(19) United States
(12) Patent Application Publication
(10) Pub. No.: US 2009/0132900 A1
(43) Pub. Date: May 21, 2009

(54) Method for producing and outputting web pages via a computer network, and web page produced thereby

(76) Inventor: Steven Zielke, Hannover (DE)

Correspondence Address: KENYON & KENYON LLP, ONE BROADWAY, NEW YORK, NY, 10004, US

(21) Appl. No.: 11/999,341

(22) Filed: Dec. 3, 2007

(30) Foreign Application Priority Data
Nov. 20, 2007 (EP) 07 022 474.6

(51) Int. Cl. G06F 17/00

(52) U.S. Cl. 715/201

(57) ABSTRACT

A method for producing and outputting web pages via a computer network, in particular the Internet, may include: recording a moving object by a video camera against a background screen; outputting a first video signal that has a plurality of pixels in chronologically successive frames in each case; modifying transparency values of the image pixels of the frames that are assigned to the background screen; outputting a second video signal; storing the second video signal as a video data file on a first memory device; and offering at least one web page for call-up from a web server in the computer network, such that the stored video data file is superimposed onto the called-up web page as video signal upon call-up of the web page from the web server by a computer via the computer network.

### FIELD OF THE INVENTION

The present invention relates to a method for producing and outputting web pages via a computer network, in particular the Internet, and to a web page produced thereby.

### BACKGROUND INFORMATION

In computer networks, in particular the Internet, various processors or computers are networked using specified protocols. From web servers or hosts in the world wide web, a user can call up web pages as data files having a predefined format, such as Hyper Text Markup Language (HTML) documents or eXtensible Markup Language (XML) documents, in that a browser program of the user's computer requests the particular network address of the web server.

The browser program usually displays the requested web pages on the requesting computer as a two-dimensional graphic surface, i.e., in a window. Static web pages are displayed by simple data files stored on the web server. In addition, dynamic web pages are known in which a program is started in response to the request, which gathers the data and transmits it to the browser in the form of a data file, it being possible to represent variable displays or video films.

Dynamic web pages are able to illustrate more complex relationships. For instance, this also allows for the call-up of a training program or an explanation of a displayed web page.

However, it has become apparent that conventional web pages, in which moving symbols, image elements or artificial bodies, so-called avatars, explain relationships, are in some cases perceived as too difficult to understand by the users.

### SUMMARY OF THE INVENTION

An object of the present invention is to provide a method for producing and outputting web pages that allows for a novel dynamic design and retroactive updating at little effort and expense. In addition, a corresponding web page is to be produced.

Embodiments of the present invention provide such a method and further provide a system for implementing the method and a web page produced via the method.

Furthermore, the present invention relates to a method for superimposing video data files onto web pages.

The present invention is based on the idea of producing a dynamic web page in which a previously recorded video data file of a moving object is inserted as a video signal. To this end, a video camera records in advance a moving object against a neutral background, in particular a monochrome background, which is also known a chroma key method or, depending on the background color employed, as blue screen, blue box or green screen technology. The moving object may be, in particular, a person who explains the web page to be displayed subsequently with the aid of appropriate gestures or movements as well as speech. This particular person may present various areas that display relevant information on the web page, using, in particular, gestures, hand movements, head movements and glances. According to the present invention, a facial expression or speech motion is thus considered a motion as well.

Using, for example, conventional methods, the video signal is then processed in that the image pixels corresponding to the background are displayed transparently, i.e., at a transparency value or alpha value of zero. The video data file produced in this manner will then be stored. In particular, it may be stored on an additional program server, which differs from the web server offering the web page.

If an Internet user calls up the Internet address of the web server having the stored web page via the browser program of the user's computer, the program is started. To this end, in particular, the user may call up the program server again via the Internet and request the video data file currently stored there. Storing the video data file on a separate program server, separately from the web page, allows for simple, separate updating of the video data file independently from the web page. To this end, the video data file and the program to be executed on the web page may be offered, stored and maintained by an external service provider on its program server, so that the owner of the web server is relieved of such complex functions.

The program called up on the program server subsequently superimposes the stored video data file onto the web page. According to the present invention, the object previously recorded by the video camera is displayed directly on the web page. Since the image pixels surrounding the moving object in the individual frames are transparent, the user therefore perceives this object as one that seems to be moving directly on the web page.

According to the present invention, this already makes it possible to create an animated impression that appeals to the user. In comparison with the known display of moving motifs and image elements, including the display of avatars or other artificial bodies, an appearance that has considerable psychological and educational appeal is able to be achieved. This is based on the finding according to the present invention that artificial artifacts have only a very limited effect on motivating users of the Internet. Instead, it is clear that viewers respond much better to explanations by a person such as a teacher in a training course and, furthermore, such explanations allow for a more personal presentation.

According to the present invention, the called up program on the web page may also operate interactively, i.e., it is able to interact with the web page. In particular, it is able to activate links offered on the web page and start other functions, for instance by activating provided buttons. According to the present invention, the sequence of movements of the moving object, i.e., of the person, in particular, may be coordinated with these interactions, so that the viewer of the dynamic web page is given the impression that the moving person is initiating the respective functions and elucidating these functions in the process.

Furthermore, the program is also able to switch between different web pages. Thus, the superimposed video signal is first displayed on a first web page and subsequently on an additional web page, which is started afterwards, preferably in conjunction with a corresponding explanation by the moving object, for example.

Explanations and introductions in connection with an Internet presentation including different functions and a plurality of web pages are therefore possible as well.

The video data file as well as the program for superimposing the video data file onto the web page may generally also be stored on the web server itself.

### BRIEF DESCRIPTION OF THE DRAWINGS

FIG. 1 shows a block diagram of a system according to an example embodiment of the present invention.

FIG. 2 shows the display of Internet pages on a display device, according to an example embodiment of the present invention.

FIG. 3 shows a flow chart of a method according to an example embodiment of the present invention.

### DETAILED DESCRIPTION

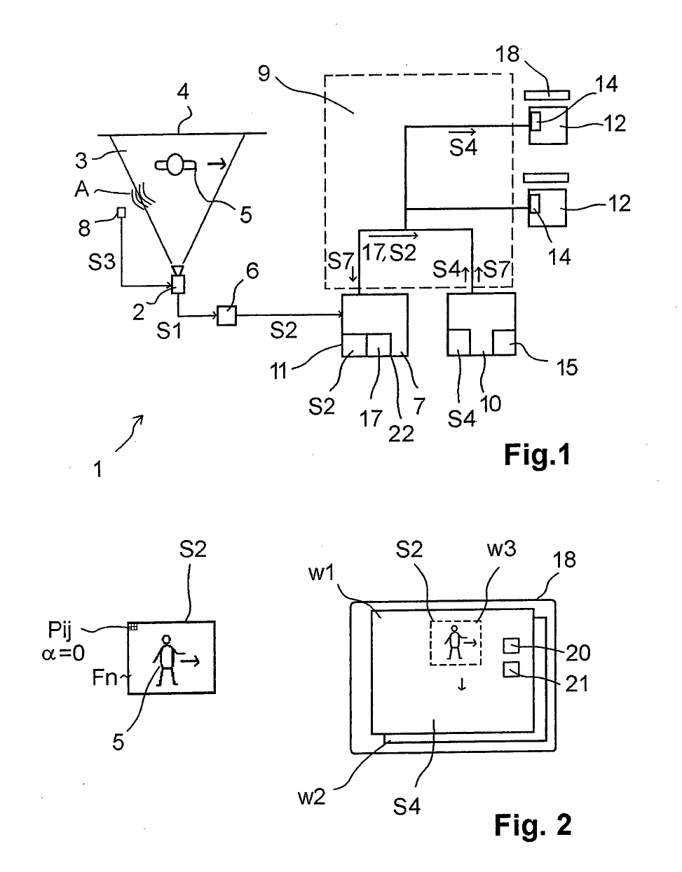

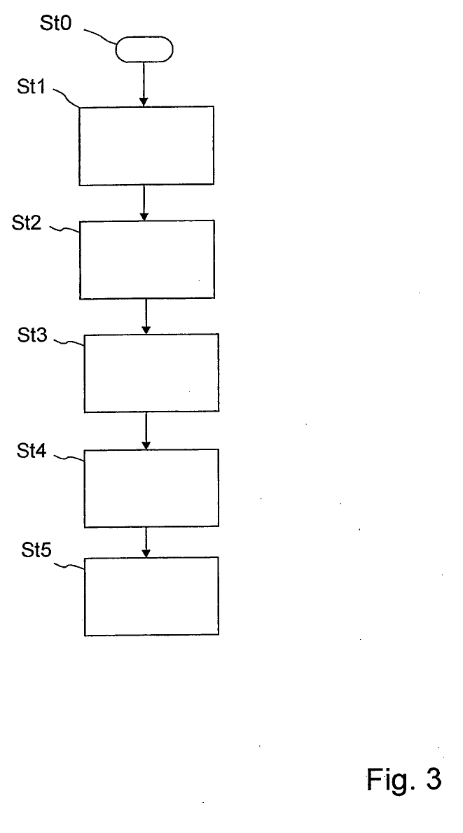

System 1 shown in FIG. 1 provides a video camera 2 in whose recording range 3 a background screen 4 is situated and a moving object 5 is disposed in front of background screen 4. Background screen 4 has a uniform color, such as blue in the case of a blue screen method.

Video camera 2 outputs a first signal S1 having frame signals Fn to a processing device 6. Frame signals Fn include pixels Pij in the known manner. Different transparency values a are assigned to pixels Pij in processing device 6. The particular pixels Pij on which screen 4 is imaged are assigned transparency value α=0 i.e., complete transparency. Such a method is already known per se in image compositions produced via superimposing or alpha blending. The particular pixels Pij that represent object 5 are displayed without transparency.

Processing device 6 outputs image signals S2 to a program server 7, which is equipped with a memory device 11 for video signal S2. In this context, processing device 6 may be realized as a separate computer device or also purely in software, for example even directly in program server 7.

Object 5 advantageously is a person who performs movements in recording range 3 and additionally outputs audio signals A, which are recorded by a microphone 8, microphone 8 outputting electric audio signals S3 to video camera 2 for incorporation in first video signal S1. For this purpose, microphone 8 may be integrated in video camera 2.

Program server 7 is connected to a computer network or Internet 9. Connected to Internet 9 are a web server 10 and additional computers (processors) 12, which may access web server 10 via Internet 9. To this end, a browser program 14 is installed on each computer 12, which, in response to an activation, calls up the Internet address of second server 10 via Internet 9 and thereby starts a server program 15 installed on second server 10.

If a computer 12 connected to Internet 9 accesses second server 10 via its browser 14 upon input of the corresponding Internet address or computer network address, then second server 10 transmits an Internet page as signal S4 to computer 12 via Internet 9, i.e., the Internet page or web page is transmitted to computer 12 as signal S4 via Internet 9.

According to an example embodiment of the present invention, when Internet page S4 is requested, a program 17 is started, which is stored in a second memory device 22 on program server 7. Both memory devices 11, 22 may be embodied as shared memory. Video data file S2 is transmitted to second server 10 via Internet 9 or also via another data link, program 17 making it possible to incorporate video data file S2, as elucidated in the following text with reference to FIG. 2.

Web page (Internet page) S4 is displayed in a manner known per se on monitor 18 connected to computer 12. In so doing, program 17 incorporates video signal S2 in Internet page S4. The incorporation may be implemented via, for example, the Adobe Flash program on Internet page S4. According to FIG. 2, Internet page S4 is reproduced on monitor 18 in the form of a window, i.e., in a window w1, and it is possible to display a plurality of Internet pages in a plurality of windows w1, w2, for instance. Program 17 then implements an image composition or superimposition of video signal S2 on Internet page S4. Due to the transparency of additional pixels Pij, only object 5 appears additionally in the display of Internet page S4. Video signal S2 may be shown in a subregion of window s1 or in another inserted window w3.

Program 17 is advantageously able to shift inserted window w3 on Internet page S4, in FIG. 2, in a downward direction according to the arrow. This constitutes a further movement in addition to the movement of object 5—here, a movement to the right. Furthermore, additional actions may be implemented on Internet page S4, in particular, links 20 or other activatable surfaces 21 may be activated on Internet page w1.

In so doing, object 5, e.g., specifically person 5, is able to perform actions for which the person provides appropriate spoken commentary by clicking or activating links 20 or other activatable surfaces 21.

According to the present invention, it is also possible that program 17 switches between different Internet pages and thus different windows w1, w2 in the display on monitor 18, e.g., switches from window w1 to window w2. In so doing, program 17 may also open additional windows, so that object 5 is subsequently displayed in the newly opened window.

As a result, program 17 is able to move freely on displayed Internet page w1, w2. Program 17 is able to switch between the plurality of Internet pages, and thus displayed windows w1, w2, and remember previous Internet pages, so that it is able to perform even complex navigations.

Program 17 may also interact with web page S4 in the process, such interactions being possible using the corresponding programming language such as JavaScript or another script language or programming language.

In the method according to an example embodiment of the present invention, following the start in step St0, one video data file or a plurality of video data files is generated in advance in a step St1 as video signals S2 and stored in program server 7. In a subsequent query by a computer 12 via Internet 9, browser 14 of computer 12 calls up Internet page S4 from second server 10 in step S1. Second server 10 activates program 17 in program server 7 in step S3. Subsequently, in step S4, program 17 incorporates video signal S2 as a superimposition on the Internet page (web page S4), these data, in step S5, being transmitted via Internet 9 to computer 12 again where they are displayed on monitor 18.

1-14. (canceled)

15. A method for producing and outputting web pages, comprising:
generating, by a video camera, a first video signal representing an object moving against a background screen, the first video signal including a plurality of pixels in successive frames, wherein the pixels have respective transparency values and wherein a subset of the pixels are assigned to the background screen;
modifying the transparency values of the subset of pixels to produce a second video signal;
storing the second video signal in a first memory device; and
responsive to a request for a download of a web page from a web server in a computer network, providing the web page with the second video signal superimposed on the web page.

16. The method of claim 15, wherein the computer network is the Internet.

17. The method of claim 15, wherein the second video signal is stored in a video data file on the first memory device and is obtained from the video data file on the first memory device for its superimposition on the web page.

18. The method of claim 15, further comprising:
responsive to the request, the web server activating a stored program, wherein the program, in response to the activation, superimposes the video data file onto the web page.

19. The method of claim 18, wherein the program is stored in a second memory device separate from the first memory device.

20. The method of claim 18, wherein the program at least one of executes instructions and starts actions on the web page.

21. The method of claim 18, wherein the program operates interactively with the web page.

22. The method of claim 18, wherein the program opens additional web pages of the web server and transmits them to a computer that has made the request.

23. The method of claim 18, wherein the program operates on a plurality of web pages and displays portions of the second video signal in succession in different windows.

24. The method of claim 18, wherein the web server accesses a server via the computer network to retrieve the second video signal and the program in response to the request.

25. The method of claim 18, wherein the program is stored in the first memory device and the first memory device is integrated in the web server.

26. The method of claim 15, wherein:
the web page occupies a display area in a user interface on a display device; and
the superimposed second video signal is displayed in only a subregion of the display area, a position of the subregion within the display area varying over time.

27. The method of claim 26, wherein the user interface is a window, and the subregion is one of a modifiable subregion of the window and subwindow superimposed on the window.

28. The method of claim 15, wherein:
the background screen has a uniform color value; and
the modification of the transparency values includes setting the transparency values of all of the pixels having the uniform color value to complete transparency.

29. The method of claim 28, wherein a transparency value of 0 represents the complete transparency.

30. The method of claim 28, wherein the uniform color is of one of a green color value and a blue color value.

31. The method of claim 15, wherein the object is a person.

32. A method for one of superimposing and overlaying video files onto web pages, comprising:
generating, by a video camera, a first video signal representing an object moving against a background screen, the first video signal including a plurality of pixels in successive frames, wherein the pixels have respective transparency values and wherein a subset of the pixels are assigned to the background screen;
modifying the transparency values of the subset of pixels to produce a second video signal;
storing the second video signal in a video file on a first memory device; and
responsive to a request for a download of a web page from a web server in a computer network, providing the web page with the second video signal obtained from the video file superimposed on the web page.

33. A system for producing and outputting web pages, comprising:
a video camera configured to generate a first video signal representing an object moving against a background screen, the first video signal including a plurality of pixels in successive frames, wherein the pixels have respective transparency values and wherein a subset of the pixels are assigned to the background screen;
a memory device; and
a processor configured to:
modify the transparency values of the subset of pixels to produce a second video signal;
store the second video signal in the memory device; and
responsive to a request for a download of a web page from a web server in a computer network, provide the web page with the second video signal superimposed on the web page.
